(19) United States
(12) Patent Application Publication
(10) Pub. No.: US 2010/0214977 A1
(43) Pub. Date: Aug. 26, 2010

(54) FEMTO-CELL MANAGEMENT BASED ON COMMUNICATION NETWORK BACKHAUL CAPABILITY

(75) Inventor: Harsha Hegde, Hawthorn Woods, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/391,291

(22) Filed: Feb. 24, 2009

(51) Int. Cl. H04W 8/00; H04M 11/00

(52) U.S. Cl. 370/328; 455/406; 455/422.1

(57) ABSTRACT

A method and apparatus for managing femto-cells based on communication network backhaul capability includes a step 202 of determining a communication capability of a backhaul Internet Service Provider connection for the femto-cell. A next step 206 includes creating a messaging element defining the Internet Service Provider backhaul connection communication capability. A next step 208 includes establishing policy rules for the femto-cell based on the messaging element. A next step 210 includes managing communications for the femto-cell per the policy rules

### FIELD OF THE INVENTION

This invention relates to wireless communication networks, and in particular, to a mechanism for managing femto-cell base stations based on communication network backhaul capability.

### BACKGROUND OF THE INVENTION

Upcoming wireless Fourth Generation (4G) communication systems, such as Long Term Evolution (LTE), Worldwide Interoperability for Microwave Access (WiMAX), and Ultra Mobile Broadband (UMB), will offer end-users higher and higher communication bandwidth. These systems are also being designed with a communication hierarchy consisting of larger macro-cell coverage, and smaller micro-cell, pico-cell, or femto-cell coverage underlaying the macro-cell. As used herein, the term femto-cell will be used for any cell underlaying a macro-cell, such as a micro-cell, pico-cell, or femto-cell. End-users in these systems will be able to subscribe to high bit rate service plans offering communication rates from 1 Mbps to 100 Mbps, with the highest available Quality of Service (QoS). To support these rates, communication networks are being designed with appropriate wireless backhaul and transport systems.

Typically, a femto-cell is operable within a user's home environment, and will use an Internet Service Provider (ISP) connection as the backhaul connection with a femto-cell gateway. As a result, when subscribers in the macro-cell wireless communication environment move to a home femto-cell coverage area, they may experience limited backhaul bandwidth and QoS depending on the available ISP connections between femto-cells and the femto-cell gateway. However, a problem arises in that the wireless communication system operator will continue to support and use subscribed service plans to reserve appropriate macro-cell bandwidth with no understanding for ISP backhaul limitations for home femto-cells. This will result in macro-cell bandwidth/QoS allocations being under utilized since the subscriber is now using an ISP connection, and also result in decreased capacity due the reserved but unused bandwidth/QoS, when the wireless communication system is capable of supporting more users and bandwidth. In addition, another problem arises in billing, wherein billing for home femto-cell users with ISP backhaul limitations, while not using the macro-cell system, should be different, which is not supported now.

Thus, there exists a need in the field of the present invention to determine a backhaul capability of femto-cells. In particular, it would be of benefit to use the backhaul capability in the management of femto-cells, and further to increase macro-cell capability.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 shows an overview block diagram of a 4G communication system, in accordance with the present invention;

FIG. 2 is a flow chart illustrating a method, in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### DESCRIPTION OF THE PREFERRED EMBODIMENTS

The present invention provides a framework to determine a backhaul capability of femto-cells. This information is used in the management of femto-cells. This information is also used to increase the capability of macro-cell coverage. This information can also be used to change the billing for particular subscribers, as will be described below. As described herein, a femto-cell base station, home base station, home Node B (HNB), home enhanced NodeB (H(e)NB), and femto-cell access point all refer to the same entity.

The following description focuses on embodiments of the invention applicable to 4G and LTE communication systems. However, it will be appreciated that the invention is not limited to this application but may be applied to many other cellular communication systems such as a 3rd generation (3G) cellular communication systems based on Code Division Multiple Access (CDMA) technology, such as the Universal Mobile Telecommunication System (UMTS), for example. Also, the description will focus on scenarios of a serving gateway of one or more femto-cell access points. However, it will be appreciated that the principles described herein could be apply equally well to other communication scenarios.

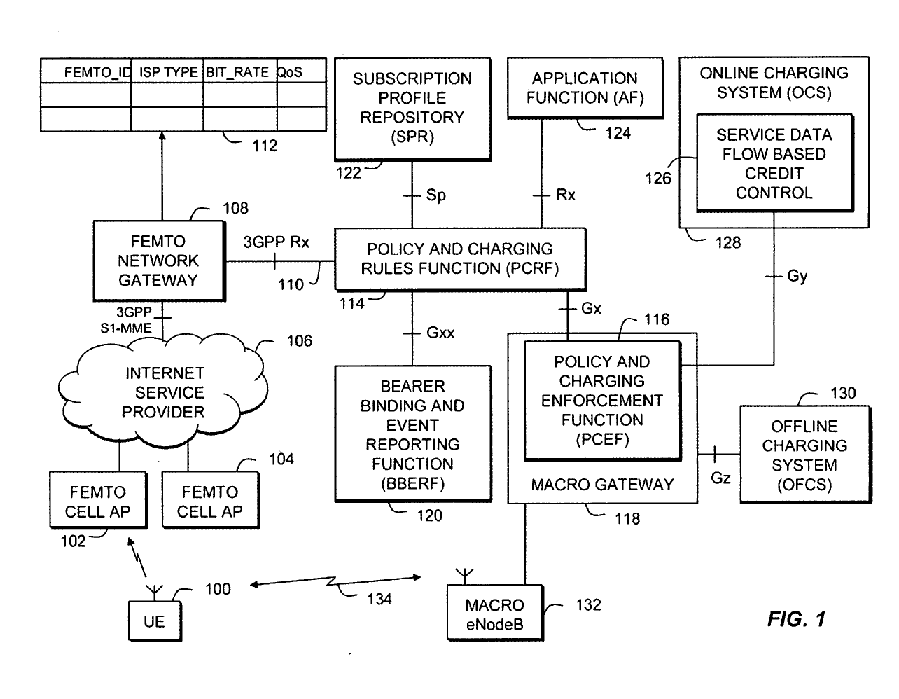

FIG. 1 illustrates an example of a 4G communication system which in the specific example is a LTE communication system implementing femto-cells connected to a femto network gateway 308 through a home ISP connection 306. In the system, a macro-layer is formed by macro-cells supported by base stations (not shown). Furthermore, an underlay layer of pico-cells or femto-cells 302, 304 are supported by a home base stations which henceforth will also be referred to as access points. Specifically, each access point 302, 304 may have an intended coverage of a single house or dwelling, or even individual rooms.

In the specific example of FIG. 1, a femto-cell access point (AP) 102 is illustrated which supports a femto-cell within a dwelling. The AP 102 is coupled to a femto-cell network gateway (FNG) 108 through an internet connection 106 and an existing 3GPP S1-SME interface. The FNG 108 is furthermore coupled to a Policy And Charging Rules Function (PCRF) 114 through an existing 3GPP Rx interface 110. The PCRF interfaces to other network elements known in the art, including a Subscription Profile Repository (SPR) 122, Application Function (AF) 124, a Service Data Flow Based Credit Control 126 in an Online Charging System (OCS) 128, an Offline Charging System (OFCS) 130, a Bearer Binding And Event Reporting Function (BBERF) 120, and a Policy And Charging Enforcement Function (PCEF) 116 in a macro-layer Gateway 118 coupled to a macro-eNodeB that is capable of communicating with a subscriber 100 on a macro-layer communication network. The FNG 108 is responsible for security, authentication, and aggregation. It should be recognized that the FNG 108 of the invention can be represented equally as an Access Point Concentrator or Controller (APC), AP Registration Server, Virtual Private Network (VPN), Generic Access Network (GAN), Universal Mobile Access (UMA), or any other server, network gateway, or authority as are known in the art.

In operation, the present invention is triggered upon a subscriber user equipment 100 handing off from a macro-cell enhanced NodeB (ENB) 132 and handing in to a femto-cell access point (AP) 102 or 104. At this point, the UE 100 is no longer using the macro-layer resources 134 reserved for it through a macro eNB 132 and associated macro gateway 118, but is instead using an Internet Service Provider (ISP) connection as a backhaul connection from its serving femto-cell AP 102 to an associated femto network gateway (FNG) 108. By leaving the macro-layer communication network, the UE 100 frees up macro-layer communication capability. However, at this point the macro gateway 118 will continue to support and use the subscribed service plans to reserve appropriate macro-cell bandwidth with no understanding for ISP backhaul limitations for the femto-cell AP 102.

In order remedy this situation, the present invention determines a communication capability 112 of a backhaul ISP connection 106 for the femto-cell 102 in order to provide this information to the macro-layer network, i.e. 118, 132. The determination of the communication capability 112 of the backhaul ISP connection 106 can be done in different ways. In one technique, the FNG 108, which is responsible for security and aggregation, could determine and track the type of ISP connection 106 using deep packet inspection for each femto-cell AP 102, 104 connected to it. In another technique, the FNG 108 could determine the type of ISP connection 106 by associating location information, which could be GPS-derived or a physical address which is supported by the femto-layer management system (e.g. FNG 108), for each femto-cell AP 102, 104 connected to it with a predetermined type of ISP connection for that location. In yet another technique, the FNG 108 could send standards-based 3GPP S1-MME (Mobility Management Entity) messages to the femto-cell AP 102 to request radio parameters based on backhaul capabilities (e.g. channel bandwidth, desired bit rate, frequency plan, assigned resource blocks, a desired transmit power per channel, etc.) from the femto-cell AP 102.

Once the communication capability of the ISP backhaul connection 106 is determined, the FNG 108 would configure the femto-cell AP 102 to use appropriate communication resources, i.e. channel bandwidth, allocated bandwidth, allocated Quality of Service (QoS) etc. with respect to the ISP backhaul connection limitations. In other words, the femto-cell AP 102 is directed to tell its served UE 100 that it is limited to use resources no greater then that available from the femto-cell ISP connection 106.

In addition, while the ULE 100 was still in femto-cell coverage, the FNG 108 would create a messaging element defining the ISP backhaul connection 106 for that femto-cell AP 102, and then send a standards-based 3GPP Rx protocol interface message request containing this element 110 to the Policy and Charging Rules Function (PCRF) 114. The PCRF 114 operates like an application function to control policy and charging for femto-cell users. In this way, the PCRF 114 would treat the FNG 108 as any other application function and set or update the policy enforcement and charging rules in the macro gateways 118 based on the request from the FNG 108. In particular, whenever the PCRF 114 sees the element 110 from the FNG 108, the PCRF 114 would then change the policy and charging for the user of the femto-cell AP 102 associated with that element in accordance with the rules previously stored in and/or retrieved from the macro gateway 118. The policy rules contain the bandwidth limitations, QoS limitations, etc. of the backhaul ISP connection associated with the element. When the PCRF 114 sees the element 110 from the FNG 108, the PCRF 114 could then take action according to the policy rules, i.e. remove bandwidth for the femto-cell, determine which applications can (e.g. text message) or cannot (e.g. Voice over IP) be used by the ISP depending upon its backhaul communication limitations, etc.

The policy rules can also contain charging rules for a Policy And Charging Enforcement Function (PCEF) 116, wherein a user that is using the reduced capabilities of femto-cell coverage and a femto-cell ISP backhaul connection could be billed less than the normal subscribed rate charged for using the macro-layer connection by the PCEF 116.

In an optional embodiment, upon receiving the element 110 the PCRF 114 could inform the macro-layer network 118, 132 that a particular macro-layer user is now using a femto-cell backhaul connection and no longer using macro-layer communications. The macro-layer gateway, realizing that it has underutilized macro-layer resources, could then proceed to bring in more subscribers requesting access to macro-layer communications, or could increase bit rate, QoS, etc. for existing macro-layer users. These benefits can be realized even though macro-schedulers (i.e. macro-layer eNBs) still need to keep some bandwidth/resources allocated, in order to guarantee/honor accepted QoS/Policy terms.

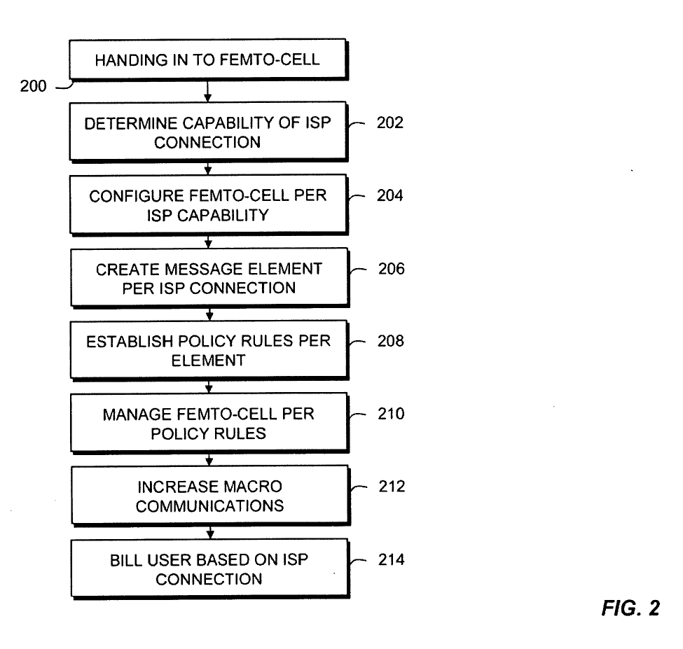

Referring now to FIG. 2, a flowchart illustrates a method for managing femto-cells based on communication network backhaul capability.

The method includes a first step 200 of a user equipment handing off from a macro-cell and handing in to a femto-cell.

A next step 202 includes determining a communication capability of a backhaul Internet Service Provider (ISP) connection for the femto-cell. This step can include using a deep packet inspection of communications of the femto-cell and associating results of the inspection with the backhaul ISP connection. This step can also include determining a location of the femto-cell and associating the backhaul ISP connection for that location. Alternatively, this step can include requesting radio parameters from the femto-cell, wherein the radio parameters are based on backhaul capabilities of the ISP connection. These radio parameters can include channel bandwidth of the backhaul ISP connection, a frequency plan for the femto-cell, a desired transmit power per channel for the femto-cell, a desired bit rate, or any other parameter relating to communication capabilities and capacity.

A next step 204 includes configuring the femto-cell to use appropriate communication resources with respect to the ISP connection communication capability.

A next step 206 includes creating a messaging element defining the ISP backhaul connection communication capability.

A next step 208 includes establishing policy rules for the femto-cell based on the messaging element.

A next step 210 includes managing communications for the femto-cell per the policy rules.

Optionally, a next step 212 includes increasing communication capabilities of macro-layer subscribers when a subscriber is detected using the femto-cell backhaul ISP connection.

Optionally, a next step 214 includes billing a subscriber of the femto-cell based on the backhaul capability of the ISP connection for the femto-cell.

Advantageously, in the present invention the allocated bandwidth and QoS would be better utilized and the bandwidth/QoS allocation for GBR and dedicated bearers can be better planned by the scheduler (i.e. macro-layer enhanced NodeB). For example, a typical home broadband connection supports a rate of about 1 Mbps. Assuming 2.5 subscribers/home and an average subscribed 4G wireless broadband of 2 Mbps/subscriber would require 10 Mbps backhaul bandwidth (based on sample traffic models for femto-cells). The present invention would results in a savings of up to 9 Mbps if dynamic policy/QoS based on backhaul capability is applied. In addition, the present invention allows that billing based on femto zone coverage and backhaul capability would help operators differentiate their service from other operators. Smart schedulers take into account the fact that the allocated resources can be underutilized, and can therefore bring in more macro-layer subscribers or increase the capability of existing macro-layer subscribers. However, it should be noted that these schedulers still need to keep some bandwidth/resources allocated, in order to guarantee/honor accepted QoS/Policy terms even when being underutilized.

It will be understood that the terms and expressions used herein have the ordinary meaning as is accorded to such terms and expressions by persons skilled in the field of the invention as set forth above except where specific meanings have otherwise been set forth herein.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for managing femto-cells based on communication network backhaul capability, the method comprising the step of:
determining a communication capability of a backhaul Internet Service Provider connection for a femto-cell;
creating a messaging element defining the Internet Service Provider backhaul connection communication capability;
establishing policy rules for the femto-cell based on the messaging element; and
managing communications for the femto-cell per the policy rules.

2. The method of claim 1, wherein the determining step includes using a deep packet inspection of communications of the femto-cell, and associating results of the inspection with the backhaul Internet Service Provider connection.

3. The method of claim 1, wherein the determining step includes determining a location of the femto-cell and associating the backhaul Internet Service Provider connection for that location.

4. The method of claim 1, wherein the determining step includes requesting radio parameters from the femto-cell, wherein the radio parameters are based on backhaul capabilities of the Internet Service Provider connection.

5. The method of claim 4, wherein the requesting step includes a radio parameter of channel bandwidth of the backhaul Internet Service Provider connection.

6. The method of claim 4, wherein the requesting step includes a radio parameter of a frequency plan for the femto-cell.

7. The method of claim 4, wherein the requesting step includes a radio parameter of assigned resource blocks for the femto-cell.

8. The method of claim 4, wherein the requesting step includes a radio parameter of a desired transmit power per channel for the femto-cell.

9. The method of claim 1, further comprising the step of billing a subscriber of the femto-cell based on the backhaul capability of the Internet Service Provider connection for the femto-cell.

10. The method of claim 1, further comprising the step of increasing communication capabilities of macro-layer subscribers when a subscriber is detected using a femto-cell backhaul Internet Service Provider connection.

11. A method for managing femto-cells based on communication network backhaul capability, the method comprising the step of:
a user equipment handing off from a macro-cell and handing in to a femto-cell;
determining a communication capability of a backhaul Internet Service Provider connection for the femto-cell;
configuring the femto-cell to use appropriate communication resources with respect to the Internet Service Provider connection communication capability;
creating a messaging element defining the ISP backhaul connection communication capability;
establishing policy rules for the femto-cell based on the messaging element;
managing communications for the femto-cell per the policy rules, and
increasing communication capabilities of macro-layer subscribers when a subscriber is detected using the femto-cell backhaul Internet Service Provider connection.

12. The method of claim 11, wherein the determining step includes using a deep packet inspection of communications of the femto-cell and determining a location of the femto-cell, and associating results of the inspection with the backhaul Internet Service Provider connection for that location.

13. The method of claim 11, wherein the determining step includes requesting radio parameters from the femto-cell, wherein the radio parameters are based on backhaul capabilities of the Internet Service Provider connection.

14. The method of claim 13, wherein the requesting step includes a radio parameter selected from one of the group of, channel bandwidth of the backhaul Internet Service Provider connection, a frequency plan for the femto-cell, and a desired transmit power per channel for the femto-cell.

15. The method of claim 13, wherein the requesting step includes a radio parameter of a desired bit rate.

16. The method of claim 11, further comprising the step of billing a subscriber of the femto-cell based on femto-cell coverage and the backhaul capability of the Internet Service Provider connection for the femto-cell.

17. A communication network for managing femto-cells based on backhaul capability, the network comprising:
a femto network gateway operable to determine a communication capability of a backhaul Internet Service Provider connection for a femto-cell and create a messaging element defining the Internet Service Provider backhaul connection communication capability; and
a Policy And Charging Rules Function operable to establish policy rules for the femto-cell based on the messaging element, and manage communications for the femto-cell per the policy rules.

18. The communication network of claim 17, wherein the Policy And Charging Rules Function is also operable to direct a macro-layer gateway to increase communication capabilities of macro-layer subscribers when a subscriber is detected using a femto-cell backhaul Internet Service Provider connection.

19. The communication network of claim 17, further comprising a Policy And Charging Enforcement Function operable to bill a subscriber of the femto-cell based on the backhaul capability of the Internet Service Provider connection for the femto-cell.
